(19) United States
(12) Patent Application Publication
(10) Pub. No.: US 2017/0137582 A1
(43) Pub. Date: May 18, 2017

(54) RUBBER COMPOSITION AND PNEUMATIC TIRE

(71) Applicant: TOYO TIRE & RUBBER CO., LTD., Osaka-shi, Osaka (JP)

(72) Inventors: Kenji Nomura, Osaka-shi (JP); Makoto Tanaka, Osaka-shi (JP)

(73) Assignee: TOYO TIRE & RUBBER CO., LTD., Osaka-shi, Osaka (JP)

(21) Appl. No.: 15/322,530

(22) PCT Filed: Mar. 17, 2015
(86) PCT No.: PCT/JP2015/001488

§ 371 Date: Dec. 28, 2016

(30) Foreign Application Priority Data
Aug. 4, 2014 (JP) 2014-158880

(51) Int. Cl. C08J 3/22; C08K 3/04; C08L 7/00; B60C 1/00

(52) U.S. Cl. CPC C08J 3/226; B60C 1/0041; C08K 3/04; C08L 7/00; C08K 2201/006; C08J 2307/00; C08J 2409/06; C08L 2201/08; C08K 2201/001

(57) ABSTRACT

A rubber composition that can achieve both low heat generation performance and conductivity is provided. The rubber composition is obtained by dry mixing a wet masterbatch containing diene rubber and carbon black A having a nitrogen adsorption specific surface area (N₂SA) of from 70 to 120 m²/g with carbon black B having a nitrogen adsorption specific surface area (N₂SA) smaller than that of the carbon black A. The ratio of the carbon black B to the total carbon black in the rubber composition is from 15 to 48 mass %.

### TECHNICAL FIELD

The present invention relates to a rubber composition and a pneumatic tire using the same.

### BACKGROUND ART

Using a wet masterbatch is known as a technology for improving dispersibility of carbon black to a rubber component such as diene rubber (see Patent Documents 1 to 4). The wet masterbatch is obtained by mixing a slurry solution obtained by dispersing carbon black in a dispersion medium such as water with a rubber latex solution, followed by coagulating and drying. In a rubber composition using the wet masterbatch, dispersibility of carbon black is improved, and as a result heat generation of the rubber composition can be suppressed, that is, low heat generation performance can be improved.

### PRIOR ART DOCUMENTS

### Patent Document

Patent Document 1: JP-A-2006-225598

Patent Document 2: JP-A-2007-197622

Patent Document 3: JP-A-2012-184354

Patent Document 4: WO 2011/145586

### SUMMARY OF THE INVENTION

### Problems that the Invention is to Solve

A rubber composition could be required to enhance low heat generation performance, and additionally to reduce electric resistance, that is, to improve conductivity. The technology of achieving both low heat generation performance and conductivity using a wet masterbatch has not conventionally been known.

The present embodiment has m object to provide a rubber composition that can achieve both low heat generation performance and conductivity.

### Means for Solving the Problems

The present inventors have found that conductivity can be improved by reducing electric resistance while enhancing low heat generation performance of a rubber composition, by a specific combination of a wet masterbatch containing carbon black and carbon black that, is added by dry mixing.

A rubber composition according to one embodiment of the present invention is a rubber composition obtained by dry mixing a wet masterbatch containing diene rubber and carbon black A having a nitrogen adsorption specific surface area (N₂SA) of from 70 to 120 m²/g with carbon black B having a nitrogen adsorption specific surface area (N₂SA) smaller than that of the carbon black A, and the ratio of the carbon black B to the total carbon black in the rubber composition is from 15 to 48 mass %.

A pneumatic tire according to one embodiment of the present invention has a ply topping rubber comprising the rabbet composition.

A method for producing a rubber composition according to one embodiment of the present invention comprises preparing a wet masterbatch using a rubber latex solution containing diene rubber and a slurry solution of carbon black A having a nitrogen adsorption specific surface area (N₂SA) of from 70 to 120 m²/g, and dry mixing the wet masterbatch obtained with carbon black B having a nitrogen adsorption specific surface area (N₂SA) smaller than that of the carbon black A such that the ratio of the carbon black B to the total carbon black in the rubber composition is from 15 to 48 mass %.

### ADVANTAGEOUS EFFECTS OF THE INVENTION

According to the present embodiment, conductivity can be improved by reducing electric resistance while enhancing low best generation performance of a rubber composition.

### MODE FOR CARRYING OUT THE INVENTION

Elements in the embodiment for carrying out the present invention are described in detail below.

A rubber composition according to the present embodiment is obtained by dry mixing a wet masterbatch WA containing carbon Mack A having a nitrogen adsorption specific surface area (N₂SA) of from 70 to 120 m²/g with carbon black B having a nitrogen adsorption specific surface area (N₂SA) smaller than that of the carbon black A. The ratio of the carbon black B to the total carbon black in the rubber composition is from 15 to 48 mass %.

Thus, carbon black having large specific surface area that is generally considered to have poor dispersibility can be effectively dispersed by forming the carbon black A having large specific surface area into a wet masterbatch. As a result, low heat generation performance can be improved. Furthermore, electric resistance can be reduced while maintaining low heat generation performance by dry mixing the carbon black B having small specific surface area in the ratio of a specific amount with the wet masterbatch WA. The reason for this is considered that the carbon black B having small specific surface area (that is, having large particle diameter) fills in spaces among the carbon black A in the wet masterbatch WA, thereby a current-carrying path can be efficiently formed. Therefore, according to the present embodiment, conductivity can be improved while enhancing low teat generation performance of a rubber composition.

The wet masterbatch WA in the rubber composition according to the present embodiment contains diene rubber and the carbon black A. Examples of the diene rubber include natural rubber (NR), polyisoprene rubber (IR), polybutadiene rubber (BR), styrene-butadiene rubber (SBR), acrylonitrile-butadiene rubber (NBR) and chloroprene rubber (CR). Of those, at least one selected from the group consisting of natural rubber, polybutadiene rubber and styrene-butadiene rubber is preferred as the diene rubber, and natural rubber is more preferred.

Carbon black having a nitrogen adsorption specific surface area of from 70 to 120 m²/g is used as the carbon black A. When the nitrogen adsorption specific surface area is 70 m²/g or more, deterioration of conductivity can be suppressed. When the nitrogen adsorption specific surface area is 120 m²/g or less, deterioration of low heat generation performance can be suppressed. The nitrogen adsorption specific surface area of the carbon black A is preferably from 70 to 100 m²/g, and more preferably from 75 to 95 m²/g. In the present description, the nitrogen adsorption specific surface area is measured according to JIS K6217-2.

The amount of the carbon black A contained in the wet masterbatch WA may be, for example, from 20 to 100 parts by mass, may be from 20 to 80 parts by mass, and may be from 25 to 60 parts by mass, per 100 parts by mass of the diene rubber.

A method for producing the wet masterbatch WA can use the conventional method, and is not particularly limited. For example, the wet masterbatch WA is obtained by mixing a slurry solution obtained by dispersing the carbon black A in a dispersion medium, with a rubber latex solution containing diene rubber, followed by coagulating and drying. One embodiment that may be used is the method described in Japanese Patent No. 4738551, that is, the method of adding at least a part of a rubber latex solution in dispersing carbon black in a dispersion medium to prepare a slurry solution containing carbon black having rubber latex particles adhered thereto, and then mixing the shiny solution with the remaining rubber latex solution, followed by coagulating and drying.

The rubber latex solution can use latex solutions of the above-described various diene rubbers, and a natural rubber latex solution is particularly preferred. The natural rubber latex solution can use a concentrated latex, a fresh latex called a field latex, and the like, without any distinction. As necessary, the rubber latex solution in which a concentration has been adjusted by adding water may be used. Examples of a synthetic rubber latex solution include a synthetic rubber latex solution produced by emulsion-polymerizing styrene-butadiene rubber, polybutadiene rubber, nitrile rubber, chloroprene rubber or the like. As the natural rubber latex solution that is a preferred embodiment, a natural rubber concentrated latex (DRC (Dry Rubber Content)=60%) manufactured by REGITEX, NR field latex (DRC=31.2%) manufactured by Golden Hope, and the like are commercially available, and can be used.

The dispersion medium in which the carbon black A is dispersed preferably uses water, but may be, for example, water containing an organic solvent. The preparation of a slurry solution and the mixing of a slurry solution with a latex solution can use a general disperser such as a high shear mixer, a high-pressure homogenizer, an ultrasonic homogenize or a colloid mill. Furthermore, a coagulating agent used in coagulating and drying can use an acid such as formic acid or sulfuric acid, or a salt such as sodium chloride, that is generally used for coagulation of a rubber latex solution. A method of dehydrating and drying after coagulation may use various drying apparatuses such as an oven, a vacuum drier or an air drier, and dehydration and drying may be conducted while applying mechanical shear force using an extruder.

As necessary, the wet masterbatch WA may contain compounding ingredients generally used is rubber industries, such as a surfactant, zinc oxide, stearic acid, as age resister, a softener such as a wax or an oil, or a processing aid, in addition to the diene rubber and the carbon black A.

The rubber composition according to the present embodiment is obtained by dry mixing the wet masterbatch WA with the carbon black B. The carbon black B is not formed into a wet masterbatch, and is directly added to the wet masterbatch WA. If the carbon black B is formed into a wet masterbatch using a rubber latex solution and added to the wet masterbatch WA electric resistance is increased, and the improvement effect of conductivity is not obtained. The reason for this is considered that in the case that the carbon black B has been formed into a wet masterbatch, the carbon black B becomes difficult to function as the above-described current-carrying path by the presence of a rubber combined with the carbon black B.

The carbon black B has a nitrogen adsorption specific surface area smaller than that of the carbon black A. Thus, electric resistance can be reduced while maintaining low heat generation performance by adding the carbon black B having small nitrogen adsorption specific surface area, therefore, having a large particle diameter, by dry mixing. The nitrogen adsorption specific surface area (NB) of the carbon black B is preferably that the difference to the nitrogen adsorption surface area (NA) of the carbon black A (NA-NB) is 20 m²/g or more. This can enhance the improvement effect of low heat generation performance. The difference (NA-NB) is preferably 30 m²/g or more. The upper limit of (NA-NB) is not particularly limited, but is generally 90 m²/g or less. The nitrogen adsorption specific surface area of the carbon black B may be, for example, from 15 to 80 m²/g, and may be from 30 to 60 m²/g.

The amount of the carbon black B added in the rubber composition of the present embodiment is set as follows. The ratio of the carbon black B to the total amount of carbon black in the rubber composition is from 15 to 48 mass %. When the ratio is 15 mass % or more, the improvement effect of conductivity by the current-carrying path can be exhibited. Furthermore, when the ratio is 48 mass % or less, the content of the carbon black A to be added as the wet masterbatch WA is secured, and both low heat generation performance and conductivity can be achieved. The ratio of the carbon black B is preferably from 20 to 45 mass %, and more preferably from 25 to 40 mass %. The total amount of the carbon black contained in the rubber composition is, for example, preferably from 30 to 150 parts by mass, more preferably from 30 to 100 parts by mass, and more preferably from 35 to 70 parts by mass, per 100 parts by mass of diene rubber that is a rubber component contained in the rubber composition.

In the dry mixing, additional diene rubber may be added to the wet masterbatch WA together with the carbon black B. The additional diene rubber is not particularly limited, and examples thereof include natural rubber (NR), polyisoprene rubber (IR), polybutadiene rubber (BR), styrene-butadiene rubber (SBR), acrylonitrile-butadiene rubber (NBR) and chloroprene rubber (CR). Those may be used in any one kind alone or as mixtures of two or more kinds. Of those, at least one kind selected from the group consisting of natural rubber, polybutadiene rubber and styrene-butadiene rubber is preferred. In the rubber composition according to the present embodiment, the diene rubber that is a rubber component preferably contains diene rubber which is added as the wet masterbatch WA, a main component. The amount of the diene rubber derived from the wet masterbatch occupies preferably 70 parts by mass or more, and more preferably 80 parts by mass or more, of 100 parts by mass of the entire diene rubber of the rubber composition. The amount may be 100 parts by mass.

Various additives generally used in a rubber composition, such as other filler such as silica, a softener such as a wax or an oil, zinc oxide, an age resister, stearic acid, a processing aid, a thermosetting resin and its hardener, a vulcanizing agent and a vulcanization accelerator, can be added in the dry mixing, other than the above-described components.

Examples of the vulcanizing agent include sulfur components such as powdered sulfur, precipitated sulfur, colloidal sulfur, insoluble sulfur and highly dispersible sulfur. Although not particularly limited, the amount of the vulcanizing agent added is preferably from 0.3 to 10 parts by mass, and more preferably from 0.5 to 5 parts by mass, per 100 parts by mass of the diene rubber. The amount of the vulcanization accelerator added is preferably from 0.1 to 7 parts by mass, and more preferably from 0.5 to 5 parts by mass, per 100 parts by mass of the diene rubber.

The dry mixing can be conducted using a mixing machine (kneading machine) generally used in kneading a rubber composition, such as Banbury mixer, a kneader or rolls. In detail, the rubber composition according to the present embodiment can be prepared by adding additives excluding a vulcanizing agent and a vulcanization accelerator to the wet masterbatch WA together with the carbon black B, followed by kneading, in a first kneading stage (non-processing kneading step), and then adding a vulcanizing agent and a vulcanization accelerator to the mixture obtained above in a final mixing stage (processing kneading step), followed by kneading.

The rubber composition thus obtained can be used in various rubber members for tires, anti-vibration rubbers, conveyer belts and the like. The rubber composition is preferably used for tires, and can be used in pneumatic tires for passenger cars and pneumatic tires of various uses and sizes, such as large-sized tires of trucks and buses.

The rubber composition has excellent low heat generation performance and conductivity as described above. Therefore, the rubber composition is preferably used as a ply topping rubber covering a reinforcing cord in a reinforcing layer of a carcass ply and the like, and a pneumatic tire can be manufactured according to the conventional method. For example, a pneumatic tire is obtained by preparing a topping texture comprising a cord covered with the rubber composition using a calendering apparatus, molding a green tire using this as a reinforcing layer, and vulcanization-molding the green tire at a temperature of, for example, from 140 to 180° C. Thus, when the rubber composition is used as a ply topping rubber, the reinforcing layer can be used as a current-carrying path of a tire. As a result, conductivity can be given to a tire without impairing low fuel consumption of a tire.

### EXAMPLES

Examples of the present invention are described below, but the present invention is not construed as being limited to those examples.

### (Raw Materials Used)

Carbon black N110: “SEAST 9” (N₂SA: 142 m²g) manufactured by Tokai Carbon Co., Ltd.

Carbon black N330: “SEAST 3” (N₂SA: 79 m²/g) manufactured by Tokai Carbon Co., Ltd.

Carbon black N339: “SEAST KH” (N₂SA: 93 m²/g) manufactured by Tokai Carbon Co., Ltd.

Carbon black N550: “SEAST SO” (N₂SA: 42 m²/g) manufactured by Tokai Carbon Co., Ltd.

Carbon black N774: “SEAST S” (N₂SA: 27 m²/g) manufactured by Tokai Carbon Co., Ltd.

Natural rubber latex solution: Solution obtained by adding water at room temperature to a natural rubber fresh latex solution manufactured by Golden Hope (DRC=31.2%) to adjust a rubber component to 25 mass %

Coagulating agent: Formic acid (first grade 85%, diluted to 10% solution to adjust pH to 1.2) manufactured by Nacalai Tesque

Natural rubber; RSS#3 made in Thailand

Styrene-butadiene rubber: “SBR1502” manufactured by Sumitomo Chemical Co., Ltd.:

Zinc flower: “Zinc Flower #1” manufactured by Mitsui Mining & Smelting Co., Ltd.

Stearic acid: “LUNAC S-20” manufactured by Kao Corporation

Oil: “JOMO PROCESS NC140” manufactured by JX Nippon Oil & Sun-Energy Corporation

Age resister: “NOCLUC 6C” manufactured by Ouchi Shinko Chemical Industrial Co., Ltd.

Sulfur: “POWDERED SULFUR” manufactured by Tsurumi Chemical Industry Co., Ltd.

Vulcanization accelerator: “NOCCELER NS-P” manufactured by Ouchi Shinko Chemical Industrial Co., Ltd.

### (Evaluation Method)

Low heat generation performance: Low heat generation performance of a vulcanized rubber obtained by vulcanizing at 150° C. for 30 minutes was evaluated by loss factor tan δ according to JIS K6265. The tan δ was measured under the conditions of 50 Hz, 80° C., static strain: 10% and dynamic strain: ±2% using a rheospectrometer E4000manufactured by UBM, and the value was indexed. The evaluation was indicated by index evaluation as the value of Comparative Example 1 being 100. The results show that tan δ is small as the numerical value is small and low heat generation performance is excellent.

Volume resistivity: Volume resistivity of a vulcanized rubber obtained by vulcanizing at 150° C. for 30 minutes was measured according to JIS K6911. The measurement conditions were applied voltage: 1000V, air temperature: 25° C. and humidity: 50%.

### Example 1

30 Parts by mass of carbon black N330 were added to a natural rubber latex solution having a solid content (rubber) concentration adjusted to 0.5 mass and the carbon black was dispersed therein using ROBOMIX manufactured by PRIME Corporation (conditions of ROBOMIX: 9000 rpm, 30 minutes). Thus, a slimy solution containing carbon black having natural rubber latex particles adhered thereto was produced (Step I). The amount of the 0.5 mass % natural rubber latex solution used was set such that the content of the carbon black to the total of water and carbon black is 5 mass % in the slurry solution obtained in the step I (the same in the preparation processes of the wet masterbatch in the following examples and comparative examples). The remaining natural rubber latex solution (adjusted by adding water such that the solid content (rubber) concentration is 25 mass %) was added to the slurry solution produced in the step I such that the total solid content (rubber) amount of the remaining natural rubber latex solution and the natural rubber latex solution used in the step I is 100 parts by mass. The resulting mixture was mixed using a household mixer SM-L56 manufactured by SANYO (mixer conditions: 11300 rpm, 30 minutes). Thus, a carbon black-containing natural rubber latex solution was produced (Step II). A 10 mass % formic acid aqueous solution as a coagulating agent was added to the carbon black-containing natural rubber latex solution produced in the step II until pH reaches 4. After solid-liquid separation using punching metal φ3.5 P manufactured by SUS, dehydration and plasticization were conducted until water content reaches 1.5% or less using a squeezer type single screw extrusion dehydrator (V-02 manufactured by Suehiro EPM Corporation). Thus, a wet masterbatch was obtained. The wet masterbatch contains 30 parts by mass of carbon black per 100 parts by mass of natural rubber as shown in the formulation of the wet masterbatch in Table 1.

Banbury mixer was used, and according to the formulation of the rubber composition in Table 1, 15 parts by mass of carbon black N550 were added to 130 parts by mass of the wet masterbatch and additionally components excluding sulfur and a vulcanization accelerator were added to and mixed with the wet masterbatch (discharge temperature: 160° C.) in a first step (non-processing mixing step). Suitor and a vulcanization accelerator were then added to and mixed with the mixture obtained (discharge temperature: 100° C.) in a second step (final mixing step). Thus, a rubber composition was prepared.

### Examples 2 to 8 and Comparative Examples 2 to 7

A wet masterbatch was prepared in the same manner as in Example 1, except that carbon black and natural rubber latex solution in the preparation of the wet masterbatch were changed as shown in the formulation of masterbatch in Tables 1 and 2. Furthermore, according to the formulation of rubber composition in Tables 1 and 2, a rubber composition was prepared by the same dry mixing as in Example 1.

### Comparative Examples 1 and 9

A rubber composition was prepared by the same dry mixing as in Example 1 according to the formulation of the rubber composition in Table 2 without preparing a wet masterbatch.

### Comparative Example 8

Wet masterbatch was prepared using each of carbon black N330 and carbon black N550. In detail, a wet masterbatch WA-1 was prepared in the same manner as in Example 1, except that the amount of carbon black N330 was 60 parts by mass per 100 parts by mass of the solid content (rubber) amount of the natural rubber latex solution, and a wet masterbatch WA-2 was prepared in the same manner as in Example 1, except that the amount of carbon black N550 was 30 parts by mass per 100 parts by mass of the solid content (rubber) amount of the natural rubber latex solution. Those wet masterbatches WA-1 and WA-2 were mixed by dry mixing such that fee total amount of rubber components is 100 parts by mass (WA-1: 80 parts by mass, WA-2: 65 parts by mass) in mass ratio of 1:1, and a rubber composition was prepared according to the formulation of the rubber composition shown in Table 2.

Low heat generation performance and volume resistivity of each rubber composition obtained were measured as properties of a vulcanized rubber. The results are shown in Tables 1 and 2.

In Comparative Example 2, in which carbon black is all formed into a wet masterbatch, that is, carbon black B was not added by dry mixing, low heat generation performance was improved, but conductivity was deteriorated, as compared with Comparative Example 1 that is a control, in Comparative Example 3, N₂SA of carbon black A formed into a wet masterbatch was too large, and low heat generation performance was deteriorated. On the other hand, in Comparative Example 4, N₂SA of carbon black A was too small, and as a result, electric resistance was too large and conductivity was deteriorated. In Comparative Example 5, the same kind of carbon black A used in the wet masterbatch was used as carbon black B to be dry mixed. Therefore, as compared with Comparative Example 1, low heat generation performance was improved, but it does not say to be sufficient, and the improvement effect of conductivity was not obtained. In Comparative Example 6, the ratio of carbon black B added by dry mixing was small, and conductivity was deteriorated. In Comparative Example 7, the ratio of carbon black B added by dry mixing was too large. As a result, low heat generation performance was improved as compared with Comparative Example 1, but electric resistance was large and conductivity was deteriorated in Comparative Example 8, two kinds of carbon blacks were formed into wet masterbatches, and dry-mixed. As a result, electric resistance was large and conductivity was deteriorated. In Comparative Example 9, carbon black having high specific surface area and carbon black having low specific surface area were dry-mixed without forming into wet masterbatches. As a result, the improvement of low heat generation performance and conductivity were insufficient as compared with Comparative Example 1. On the other hand, in Examples 1 to 8, electric resistance was reduced and conductivity was improved while remarkably improving low heat generation performance, as compared with Comparative Example 1.

TABLE 1

| | | | Ex. 1 | Ex. 2 | Ex. 3 | Ex. 4 | Ex. 5 | Ex. 6 | Ex. 7 | Ex. 8 |
|---|---|---|---|---|---|---|---|---|---|---|
| Formulation of | Natural rubber (solid content*)1 | | 100 | 100 | 100 | 100 | 100 | 85 | 100 | 100 |
| wet masterbatch | Carbon | N110 | | | | | | | | |
| (parts by mass) | black A | N330 | 30 | | 35 | 40 | 25 | 30 | 30 | |
| | | N339 | | 30 | | | | | | 30 |
| | | N550 | | | | | | | | |
| Formulation of | Wet masterbatch | | 130 | 130 | 135 | 140 | 125 | 115 | 130 | 130 |
| rubber composition | Natural rubber | | | | | | | | | |
| (parts by mass) | Styrene-butadiene rubber | | | | | | | 15 | | |
| | Carbon | N330 | | | | | | | | 15 |
| | black B | N550 | 15 | 15 | 10 | 10 | 20 | 15 | | |
| | | N774 | | | | | | | 20 | |

| | | | | | | | | |
|---|---|---|---|---|---|---|---|---|
| Zinc flower | 3 | 3 | 3 | 3 | 3 | 3 | 3 | 3 |
| Stearie acid | 2 | 2 | 2 | 2 | 2 | 2 | 2 | 2 |
| Oil | 10 | 10 | 10 | 10 | 10 | 10 | 10 | 10 |
| Age resister | 2 | 2 | 2 | 2 | 2 | 2 | 2 | 2 |
| Sulfur | 2 | 2 | 2 | 2 | 2 | 2 | 2 | 2 |
| Vulcanization accelerator | 1.5 | 1.5 | 1.5 | 1.5 | 1.5 | 1.5 | 1.5 | 1.5 |

| | | | | | | | | |
|---|---|---|---|---|---|---|---|---|
| N₂SA of carbon black A (m²/g) | 79 | 93 | 79 | 79 | 79 | 79 | 79 | 93 |
| N₂SA of carbon black B (m²/g) | 42 | 42 | 42 | 42 | 42 | 42 | 27 | 79 |
| Difference in N₂SA of carbon black (m²/g) | 37 | 51 | 37 | 37 | 37 | 37 | 52 | 14 |
| Ratio of carbon black B (mass %) | 33 | 33 | 22 | 20 | 44 | 33 | 40 | 33 |
| Properties of volcanized rubber | | | | | | | | |
| Low heat generation performance (index) | 72 | 75 | 75 | 80 | 76 | 76 | 74 | 86 |
| Volume resistivity (Ω · cm) | 9 × 10⁶ | 7 × 10⁶ | 1 × 10⁷ | 7 × 10⁶ | 2 × 10⁷ | 1 × 10⁷ | 8 × 10⁶ | 5 × 10⁷ |

*1Amount of solid content of natural robber derived from rubber latex molution

TABLE 2

| | | | Com. | Com. | Com. | Com. | Com. | Com. | Com. | Com. | Com. |
|---|---|---|---|---|---|---|---|---|---|---|---|
| | | | Ex. 1 | Ex. 2 | Ex. 3 | Ex. 4 | Ex. 5 | Ex. 6 | Ex. 7 | Ex. 8 | Ex. 9 |
| Formulation of | Natural rubber (solid content)*1 | | | 100 | 100 | 100 | 100 | 100 | 100 | 100 | |
| wet masterbatch | Carbon | N110 | | | 30 | | | | | | |
| (parts by mass) | black A | N330 | | 45 | | | 30 | 42 | 15 | 30 | |
| | | N339 | | | | | | | | | |
| | | N550 | | | | 40 | | | | 15 | |
| Formulation | Wet masterbatch | | | 145 | 130 | 140 | 130 | 142 | 115 | 80 + 65 | |
| of rubber | Natural rubber | | 100 | | | | | | | | 100 |
| composition | Styrene-butadiene rubber | | | | | | | | | | |
| (parts by mass) | Carbon | N330 | 45 | | | | 15 | | | | 30 |
| | black B | N550 | | | 15 | | | 3 | 30 | | 15 |
| | | N774 | | | | 15 | | | | | |

| | | | | | | | | | |
|---|---|---|---|---|---|---|---|---|---|
| Zinc flower | 3 | 3 | 3 | 3 | 3 | 3 | 3 | 3 | 3 |
| Stearic acid | 2 | 2 | 2 | 2 | 2 | 2 | 2 | 2 | 2 |
| Oil | 10 | 10 | 10 | 10 | 10 | 10 | 10 | 10 | 10 |
| Age resister | 2 | 2 | 2 | 2 | 2 | 2 | 2 | 2 | 2 |
| Sulfur | 2 | 2 | 2 | 2 | 2 | 2 | 2 | 2 | 2 |
| Vulcanization accelerator | 1.5 | 1.5 | 1.5 | 1.5 | 1.5 | 1.5 | 1.5 | 1.5 | 1.5 |

| | | | | | | | | | |
|---|---|---|---|---|---|---|---|---|---|
| N₂SA of carbon black A (m²/g) | — | 79 | 142 | 42 | 79 | 79 | 79 | 79, 42 | |
| N₂SA of carbon black B (m²/g) | 79 | — | 42 | 27 | 79 | 42 | 42 | — | 79, 47 |
| Difference in N₂SA of carbon black (m²/g) | — | — | 100 | 15 | 0 | 37 | 37 | — | — |
| Ratio of carbon black B (mass %) | 100 | 0 | 33 | 27 | 33 | 7 | 67 | 0 | 100 |
| Properties of volcanized rubber | | | | | | | | | |
| Low heat generation performance (index) | 100 | 79 | 132 | 78 | 89 | 77 | 86 | 68 | 91 |
| Volume resistivity (Ω · cm) | 8 × 10⁷ | 2 × 10⁹ | 3 × 10⁶ | 9 × 10⁸ | 1 × 10⁸ | 1 × 10⁹ | 1 × 10⁹ | 2 × 10⁹ | 3 × 10⁷ |

*1Amount of solid content of natural rubber derived from rubber latex solution

1. A rubber composition obtained by dry mixing a wet masterbatch containing diene rubber and carbon black A having a nitrogen adsorption specific surface area (N₂SA) of from 70 to 120 m²/g with carbon black B having a nitrogen adsorption specific surface area (N₂SA) smaller than that of the carbon black A, wherein the ratio of the carbon black B to the total carbon black in the rubber composition is from 15 to 48 mass %.

2. The rubber composition according to claim 1, wherein the difference between the nitrogen adsorption specific surface area of the carbon black A and the nitrogen adsorption specific surface area of the carbon black B is 20 m²/g or more.

3. The rubber composition according to claim 1, wherein the difference between the nitrogen adsorption specific surface area of the carbon black A and the nitrogen adsorption specific surface area of the carbon black B is 30 m²/g or more and 90 m²/g or less.

4. The rubber composition according to claim 1, wherein the diene rubber is at least one selected from the group consisting of natural rubber, polybutadiene rubber and styrene-butadiene rubber.

5. The rubber composition according to claim 1, wherein the wet masterbatch contains the carbon black A in an amount of from 20 to 100 parts by mass per 100 parts by mass of the diene rubber.

6. A pneumatic tire having a ply topping rubber comprising the rubber composition according to claim 1.

7. A method for producing a rubber composition, which composes:
preparing a wet masterbatch using a rubber latex solution containing diene rubber and a slurry solution of carbon black A having a nitrogen adsorption specific surface area (N₂SA) of from 70 to 120 m²/g, and
dry mixing the wet masterbatch obtained with carbon black B having a nitrogen adsorption specific surface area (N₂SA) smaller than that of the carbon black A such that the ratio of The car bon black B to the total carbon black in the rubber composition is from 15 to 48 mass %.

8. The method for producing a rubber composition according to claim 7, wherein the difference between the nitrogen adsorption specific surface area of the car bon black A and the nitrogen adsorption specific surface area of the car bon black B is 20 m²/g or more.

9. The method for producing a rubber composition according to claim 7, wherein the step for preparing the wet masterbatch comprises a step of adding at least a part of the rubber latex solution in dispersing the carbon black in a dispersion medium to prepare a slurry solution containing carbon black having rubber latex particles adhered thereto, a step of mixing the slimy solution with the remaining rubber latex solution to prepare a carbon black-containing rubber latex solution, and a step of coagulating and drying the carbon black-containing rubber latex solution.

10. A method for manufacturing a pneumatic tire, which comprises producing a rubber composition by the production method according to claim 7, preparing a topping texture comprising a cord covered with the rubber composition, molding a green tire using the topping texture as a reinforcing layer, and then vulcanization-molding the green tire.
